(19) United States
(12) Patent Application Publication
(10) Pub. No.: US 2015/0066758 A1
(43) Pub. Date: Mar. 5, 2015

(54) PAYMENT CARD SYSTEMS AND METHODS

(71) Applicants: Richard DeNardis, Chicago, IL (US); Michael Yakel, Jefferson, NC (US)

(72) Inventors: Richard DeNardis, Chicago, IL (US); Michael Yakel, Jefferson, NC (US)

(21) Appl. No.: 14/470,268

(22) Filed: Aug. 27, 2014

Related U.S. Application Data
(60) Provisional application No. 61/870,491, filed on Aug. 27, 2013.

(51) Int. Cl. G06Q 20/32; G06Q 20/34; G06Q 20/40; G06K 19/08

(52) U.S. Cl. CPC G06Q 20/3278; G06K 19/08; G06Q 20/34; G06Q 20/40
USPC 705/41

(57) ABSTRACT

According to some embodiments, a payment device having a first and a second account number may be provided. The first account number may be associated with a near field communication (“NFC”) feature of the payment device and the second account number may be associated with a magnetic stripe and/or a memory of the payment device. The first and second account numbers may be associated with a primary payment account of a cardholder, and at least a first authorization parameter associated with the first account number may be established. The payment device might be associated with, for example, a payment card, a payment card formed as a key fob, a mobile phone, and/or a portable computer.

### CROSS REFERENCE TO RELATED APPLICATION

This application claims the benefit of U.S. Provisional Patent Application No. 61/870,491 filed on Aug. 27, 2013, the contents of which are hereby incorporated by reference for all purposes.

### BACKGROUND

Most consumers use a payment device of some form. The most common form of payment device is a payment card which has a primary account number embossed or printed on a face of the card and a magnetic stripe on which the same account number and other information is encoded. The cardholder may conduct a payment transaction by swiping the payment card through a magnetic stripe reader associated with a point of transaction. The magnetic stripe reader reads the account number and other information from the magnetic stripe and then uses that information to transmit a transaction authorization request to an issuer (or agent of the issuer) of the payment card.

More recently, payment devices have been developed that allow contactless communication of the payment account information from the payment device to a reader associated with a point of transaction. These types of payment devices may be referred to herein as “proximity payment devices” and may conform to one or more wireless communication standards such as, for example, ISO Standard ISO/IEC 14443 or the like, as well as payment association standards such as MasterCard International Incorporated's PayPass standard, Visa International Service Association's PayWave, or the like. These proximity payment devices typically are formed as payment cards with a radio frequency identification (“RFID”) integrated circuit (or “chip”) embedded in a body of the payment card. An antenna, typically formed as a loop antenna, is also embedded in the body of the payment card. When the proximity payment device is presented near a proximity reader, the RFID chip is powered from an interrogation signal that is transmitted from the proximity reader and received by the proximity card antenna. A conductive connection between the antenna and the RFID chip allows the chip to receive and transmit data by RF communication via the antenna.

Such proximity payment devices enable fast and efficient payment transactions and are often used in environments where presentation of a magnetic stripe card may take longer (such as, for example, in transit applications or at quick serve restaurant locations).

Unfortunately, there has been some concern regarding the ability for fraud or theft of payment account information from these devices. It is possible, in some situations, for a fraudster to “skim” or read the payment account information by presenting a proximity device reader near a proximity payment device, causing the proximity payment device to transmit the payment account information to the fraudster's reader. The fraudster may then use the skimmed payment account information in a fraudulent transaction. Many payment systems have implemented techniques to reduce the impact of such fraud by requiring the generation of a unique card verification value for each proximity payment transaction, thereby limiting a fraudster to a single fraudulent transaction using skimmed account information. But consumers, especially in the US, remain concerned about the security of proximity payment devices.

The present inventors have recognized a need to provide systems and methods which allow payment devices to be provided with the features and efficiency of proximity payment devices with the security features of standard payment devices as well as providing for consumer/cardholder to control their risk exposure.

### BRIEF DESCRIPTION OF THE DRAWINGS

FIG. 1 is a schematic plan view of a payment device pursuant to some embodiments.

FIG. 2 is a schematic plan view of the payment device shown in FIG. 1 pursuant to some embodiments.

FIG. 3 is a flow chart that illustrates aspects of a method provided in accordance with some embodiments.

### DETAILED DESCRIPTION

In general, and for the purpose of introducing concepts of embodiments of the present invention, embodiments provide payment devices having both a proximity payment and a magnetic stripe payment capability. A first payment account number is associated with the proximity payment feature, and a second payment account number is associated with the magnetic stripe feature. Pursuant to some embodiments, both the first and the second payment account numbers may be usable by an issuer of the payment device to identify a financial account of the cardholder. Each or both of the first and second payment account numbers may be subject to different authorization processing or fraud or usage controls. For example, a cardholder (or the issuer) may establish controls that limit usage of the proximity payment feature to a certain transaction amount (e.g., the cardholder may only use the proximity payment feature for transactions under $10, etc.). As another example, the cardholder (or the issuer) may establish location or merchant category controls that limit the merchants or locations the proximity payment feature may be used with (e.g., the cardholder may only use the proximity payment feature for transactions at quick serve restaurants, or the cardholder may only use the proximity payment feature for transactions in the Chicago area). These account controls may be specified by either (or both) of the cardholder and the issuer. Further, pursuant to some embodiments, the account controls may be specified for either (or both) of the first payment account number (e.g., associated with the proximity payment feature) and the second payment account number (e.g., associated with the magnetic stripe payment feature).

While features of the present invention are described herein in proximity payment and magnetic stripe environments, embodiments may be used with similarly desirable results in contact payment devices (e.g., such as those compliant with the EMV standards), or the like. Further, while two different payment account numbers are described, embodiments may be used with more than two different payment account numbers.

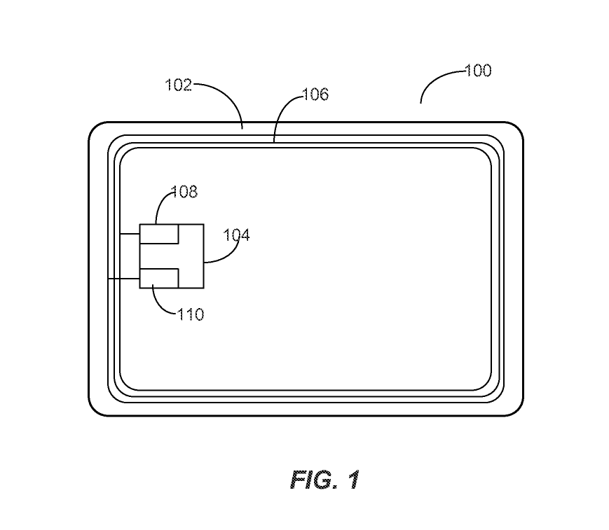

Features of some embodiments will now be described by reference to the figures. FIG. 1 is a schematic plan view of a payment device 100 pursuant to some embodiments. The payment device 100 includes a card body indicated by reference numeral 102. In some embodiments, the card body may be formed of plastic and may be generally rectangular and planar and have dimensions in accordance with the ISO/IEC 7810, 7812 standards for identification cards. In such embodiments, for example, the length of the card body 102 is substantially 85.6 mm and the width or height of the card body 102 is substantially 53.98 mm. With these dimensions, issuance of the card may be processed using conventional identification card processing equipment. Pursuant to some embodiments, the proximity payment device 100 may be formed in other form factors as well, such as, for example, in a key fob, in a mobile telephone, or the like. (Other form factors, esp. mobile phones, are referenced here but are not highlighted. Should be make sure to include this in the claims?) [see claims below]

The payment device 100 also includes an RFID chip 104. An antenna 106 is coupled to the RFID chip 104 in a conventional manner to allow for the RFID chip 104 to receive power signals from, and to exchange RF communications with, proximity reader components (not shown) of POS terminals (not shown). The RFID chip 104 is embedded in the card body 102. A first set of payment credentials are stored in the RFID chip 104. The first set of payment credentials may include, for example, a name of an account holder (to whom the payment device 100 is issued), a first payment account number, a first payment account expiration date, and a first payment account verification code. The first payment account number is an identifier that is, for example, assigned by an issuer of the payment device 100 and that is usable by the issuer of the payment device 100 to associate transactions involving the first payment account number with a payment account of the cardholder. In some embodiments, the first payment account number is formatted pursuant to payment card standards (such as ISO/IEC 7812) and may include an Issuer Identification

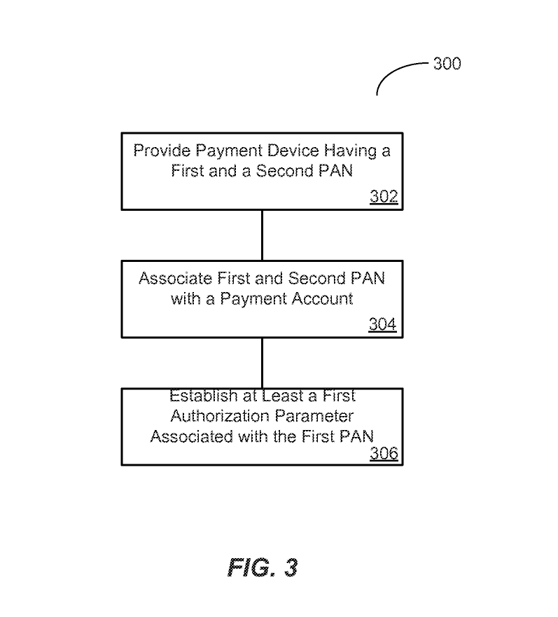

Number (“IIN”) or Bank Identification Number (“BIN”) identifying the issuer of the payment device 100 as well as an account identifier (and, in some embodiments, a checksum or check digit). The account number may be a pointer or proxy for an actual payment account of the cardholder at the issuing financial institution. As will be described further below in conjunction with FIG. 3, the first payment account number may have special or different authorization criteria established to control the usage of the payment device 100 when operated in an NFC mode of operation.

For example, in a transaction involving the RFID chip 104 of the payment device 100 (e.g., such as in an NFC transaction at an NFC reader), the first payment account number may be transmitted from the NFC reader to an issuer of the payment device 100 (or an agent of the issuer) via a payment network (such as the Banknet network operated by MasterCard International Incorporated or the like). The authorization or other processing of the transaction may be controlled by one or more parameters or criteria established by the cardholder (and/or the issuer). These parameters may include parameters that restrict transactions involving the first payment account number based on: (1) spending limits or spending velocity, (2) transaction location, (3) merchant type, (4) transaction type, or the like.

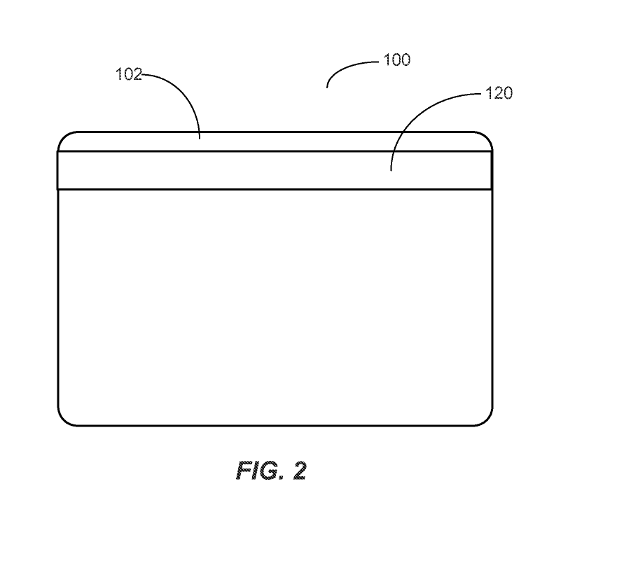

Referring now to FIG. 2, the payment device 100 may have a face or surface on which a magnetic stripe 120 is located. The magnetic stripe 120 may encode information associated with a second set of payment credentials which are readable by a magnetic stripe reader (e.g., such as at a point of sale location). The second set of payment credentials may include, for example, the name of the account holder (to whom the payment device 100 is issued), a second payment account number, a payment account expiration date (which may be the same as, or different from, the expiration date of the first payment account number), and a payment account verification code (which may be the same as, or different from, the verification code of the first payment account number).

The second payment account number is an identifier that is, for example, assigned by an issuer of the payment device 100 and that is usable by the issuer of the payment device 100 to associate transactions involving the second payment account number with a payment account of the cardholder. In some embodiments, the second payment account number is formatted pursuant to payment card standards (such as ISO/IEC 7812) and may include an Issuer Identification Number (“IIN”) or Bank Identification Number (“BIN”) identifying the issuer of the payment device 100 as well as an account identifier (and, in some embodiments, a checksum or check digit). The second payment account number may be a pointer or proxy for the actual payment account of the cardholder at the issuing financial institution. As will be described further below in conjunction with FIG. 3, the second payment account number may have special or different authorization criteria established to control the usage of the payment device 100 when operated in a magnetic stripe mode of operation.

FIG. 3 is a flow chart that illustrates a process 300 for issuing the payment device 100 of FIG. 1 pursuant to some embodiments. The process 300 may be performed by an issuer, or an agent of the issuer to issue payment devices 100 to qualifying cardholders. The process begins at 302 where the issuer provides a payment device 100 having a first and a second payment account number. As described above, the first payment account number may be one associated with an NFC feature of the payment device (and may, for example, be personalized in an RFID chip of the payment device), and the second payment account may be one associated with a magnetic stripe feature of the payment device (and may, for example, be encoded in a magnetic stripe of the payment device). At 304, the first and second payment account numbers are associated with a primary payment account of the cardholder at the issuer. For example, the primary payment account may be a credit or debit account of the cardholder at the issuer. The process continues at 306 where at least a first authorization parameter is established in association with the first payment account number. For example, the parameter may include one or more parameters that restrict transactions involving the first payment account number based on: (1) spending limits or spending velocity, (2) transaction location, (3) merchant type, (4) transaction type, or the like.

Some or all of the steps of process 300 may be repeated to associate additional account numbers with the primary account, and/or to establish additional authorization parameters. Further, in some embodiments, processing may continue to establish one or more authorization parameters for the second payment account number as well. Further, in some embodiments, the cardholder may control the establishment of one or more of the authorization parameters. For example, the cardholder may be provided with a user interface accessible via the Web or an interactive voice response unit which allows the cardholder to control or specify the establishment of one or more parameters.

The result is a payment device that allows a wide variety of usage controls, allowing a payment device to enjoy the benefits of the transaction speed of NFC payments in certain environments (such as at quick serve restaurants or transportation applications), as well as the relative security of magnetic stripe or other payment transaction types. Further, cardholders and issuers enjoy substantial control of the authorization parameters for each of the different features (e.g., allowing the cardholder to specify different authorization parameters for magnetic stripe transactions and for NFC transactions). Pursuant to some embodiments, these features and benefits are provided without requiring modification of point of sale devices, or other aspects of the payment process. Instead, the features may be provided with modifications of certain issuer processes.

The principles taught herein have heretofore been described in the context of payment devices. Nevertheless, these teachings are also applicable to cards or the like issued by transportation systems (e.g., mass transit systems) for access to the transportation systems; to cards used to identify the holder for purposes apart from or in addition to transaction payments; and to so-called electronic passports (also known as RFID-enabled passports).

The above description and/or the accompanying drawings are not meant to imply a fixed order or sequence of steps for any process referred to herein; rather any process may be performed in any order that is practicable, including but not limited to simultaneous performance of steps indicated as sequential.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method, comprising:
providing a payment device having a first and a second account number, the first account number associated with a near field communication (“NFC”) feature of the payment device and the second account number associated with at least one of (i) a magnetic stripe and (ii) a memory of the payment device;
associating the first and second account number with a primary payment account of a cardholder; and
establishing at least a first authorization parameter associated with the first account number.

2. The method of claim 1, wherein the payment device is at least one of (i) a payment card, (ii) a payment card formed as a key fob, (iii) a mobile phone, and (iv) a portable computer.

3. The method of claim 1, wherein the first account number is stored in a memory of a radio frequency identification device (“RFID”).

4. The method of claim 1, wherein the at least first authorization parameter includes a parameter that restricts transactions involving the first account number.

5. The method of claim 1, wherein the at least first authorization parameter includes one or more parameters that restrict transactions involving the first account number based on at least one of (i) a spending limit, (ii) a spending velocity, (iii) a transaction location, (iv) a merchant type, and (v) a transaction type.

6. The method of claim 1, wherein the at least first authorization parameter is a parameter specified by the cardholder.

7. The method of claim 1, wherein the at least first authorization parameter is a parameter specified by at least one of an issuer of the payment device and a cardholder.

8. The method of claim 1, wherein the second account number is accessible via a communication mode other than NFC.

9. The method of claim 1, wherein the first account number is not printed or embossed on the payment device.
